(19) United States
(12) Patent Application Publication
(10) Pub. No.: US 2006/0046828 A1
(43) Pub. Date: Mar. 2, 2006

(54) Gaming device and method featuring an award occurring on non-winning outcomes

(76) Inventors: Kim Tempest, Henderson, NV (US); Jon Leupp, Henderson, NV (US)

Correspondence Address: BERNHARD KRETEN;WEINTRAUB GENSHLEA CHEDIAK SPROULE, 400 CAPITOL MALL, 11TH FLOOR, SACRAMENTO, CA, 95814, US

(21) Appl. No.: 10/925,823

(22) Filed: Aug. 24, 2004

(51) Int. Cl. A63F 13/00

(52) U.S. Cl. 463/20

(57) ABSTRACT

A gaming device having a primary game and paying awards under certain conditions if the outcome of the primary game is not on a winning outcome.

### BACKGROUND OF THE INVENTION

Thousands of different slot machine style games have been developed over the years. Many feature a “bonus” round that a player may access if a particular symbol or combination of symbols appears in a primary game. Players are generally intrigued by such games, but play of the primary game is often “overshadowed” by the player's desire to achieve specific symbol combinations that allow the player to enter the bonus game. Players consistently enjoy games with simple premises that do not require adherence to complex rule sets, but still provide entertainment. Thus, it is desired to provide a machine that provides a game with a chance at “bonus-like” awards without the complexity of a “bonus round”. Further, since most bonus rounds are triggered by the selection and display of typically two or more bonus round symbols in the base game, there is a need to provide an award without the player obtaining the bonus round trigger symbol(s) in the base game.

It is also known in slot machine style games to provide a base game which randomly or pseudo-randomly produces an outcome which is either a winning or a losing outcome. In most such games the player makes a wager to enable one or more pay lines for the game. The outcome is presented as symbols in a display and the combinations of symbols in the display on any enabled pay line define a winning or losing outcome. For winning outcomes the player receives an award. Many modern slot machines, video and electromechanical (often referred to as stepper games) include the ability to enable many pay lines such as three, nine, twenty or more.

In addition to pay line based awards, to increase the enjoyment of the player, many modern slot machines include what is referred to as a “scatter” pay or award. Such an award is issued when two or more designated scatter symbols are selected and displayed at the base game display. Often the scatter award increases where there are ≧3 scatter symbols.

The aforementioned base game awards of line pays and scatter pays are augmented by any awards offered by a bonus feature which is typically triggered by the indicia selected and displayed in the base game.

A drawback of the prior games is that the player anticipates the appearance of winning line pay award indicia combinations as well as scatter and bonus indicia. Inasmuch as many games display the indicia in the game display in columns and in a left to right sequence to (stopping spinning, mechanical reels in sequence or controlling a video display to simulate the same), the player can sense with the outcome displayed in the first several columns if they will receive an award. Thus the anticipation of the player getting a winning outcome for the player diminishes as the outcome is revealed. For line pays, after the first two reels are displayed the player knows whether or not they will obtain a winning outcome. If the game is a five reel video slot machine game, the player may hope to get two scatter symbols on the last to reels. As can be appreciated, the hope of a getting any winning outcome is completely gone when the fourth reel displayed does not indicate a winning pay line, scatter or bonus outcome.

There is a need for a gaming device and method which retains the player's anticipation until the last column (reel) is displayed. There is a need of a device and method which provides the opportunity for an award when all other features fail to produce a winning outcome.

### SUMMARY OF THE INVENTION

The present invention is distinguishable over the prior art in that the occurrence of a non-winning (“losing”) outcome forces a subsequent evaluation of a base game losing outcome to determine if a particular symbol is present in a particular orientation. If such a symbol is present in such an orientation, the player is awarded, even though the outcome does not result in any pay line, scatter or bonus award. Other embodiments include determining if another symbol is simultaneously present in a particular orientation, and awarding an enhanced award if it is. A further embodiment includes providing for the random appearance of the particular symbol, where symbols are displayed in a sequence, near the end of the sequence to retain the player's interest.

### OBJECTS OF THE INVENTION

Accordingly, it is a primary object of the present invention to provide a new and novel device and method for generating interest in play of a gaming device.

It is a further object of the present invention to provide a device and method as characterized above in which a base game losing outcome does not necessarily mean that the player is not awarded.

It is a further object of the present invention to provide a device and method as characterized above which provides a player with the opportunity to win an award where the base game does not result in any pay line, scatter or bonus award.

It is a further object of the present invention to provide a device and method as characterized above that is simple to understand and to implement.

It is a further object of the present invention to provide a device and method which retains the player's interest until the last feature of the base game is displayed.

Viewed from a first vantage point, it is an object of the present invention to provide a gaming device, comprising, in combination: An improved gaming device of the type having a display and means for a player to input a wager to play the game. A computer processor is configured to select and display a plurality of indicia defining outcomes such as by selecting and displaying game symbols in a matrix-form in association with enabled pay lines on the display. The improvement includes a data structure storing data corresponding to game indicia and at least one feature indicia. The indicia may be game symbols consistent with the desired theme of the game and the feature symbol may be a special symbol, likewise consistent with the theme of the game or a unique symbol which may be used regardless of the game theme, e.g. a symbol reminiscent of a lifesaver.

The processor is configured to select and control the display to display game indicia to define a game winning or a losing outcome. For example game winning outcomes may be one or more of (a) winning pay line awards, (b) scatter pays as well as (c) trigger symbols which initiate the play of a bonus feature. The processor is configured to issue an award upon (1) the selection and display of said feature indicia and a game losing outcome.

Viewed from a second vantage point, it is an object of the present invention to provide a method of gaming, the steps including: accepting a wager; activating a display; displaying a primary game at the display; awarding credits for winning outcomes in the primary game; searching the outcome for a particular symbol in a particular orientation if the primary game outcome is not a winning outcome; and awarding credits if the particular symbol is displayed in the display for example, in the particular orientation and the outcome is not a winning outcome.

Viewed from a third vantage point, it is an object of the present invention to provide a gaming device, comprising, in combination: a paytable having a plurality of outcomes, each outcome comprising a plurality of symbols; a primary game displaying one outcome; comparison means to determine if the one outcome is on the paytable; award means to award credits for outcomes found to be on the paytable by the comparison means; and second comparison means to determine whether a plurality of particular symbols are located in a particular orientation in the outcome if the outcome is not present on the paytable.

These and other objects will be made manifest when considering the following detailed specification when taken in conjunction with the appended drawing figures.

### BRIEF DESCRIPTION OF THE DRAWINGS

FIG. 1 is a flowchart of the methodology according to the present invention;

FIG. 2 is a depiction of the apparatus associated therewith;

FIG. 3 is a depiction of a base game display with a pay line award; and

FIG. 4 is a depiction of a display with an award according to the method of the present invention.

### DESCRIPTION OF PREFERRED EMBODIMENTS

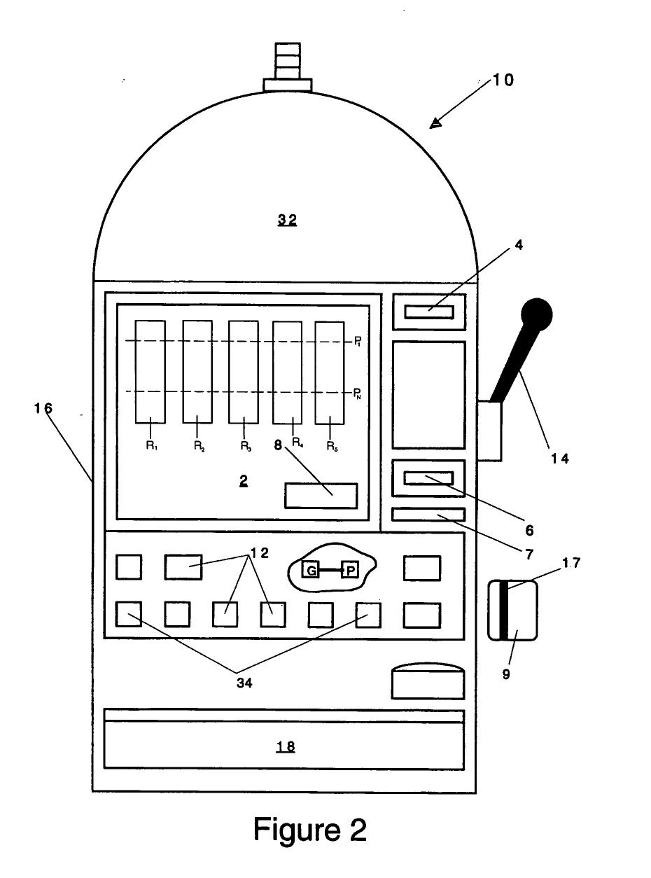

Considering the drawings, wherein like reference numerals denote like parts throughout the various drawing figures, reference numeral 10 as shown in FIG. 2 is directed to the device according to the present invention.

In its essence, the device 10 includes a housing 16 which supports a visual display 2, preferably a video monitor, there within. The display 2 may include a window 8 for special messages or for incrementing counting of credits accumulated by the player. The device also includes an LED or other readout 4 for prompting the player and can provide similar verbiage as the window 8 or in lieu thereof, to stimulate the player. The device includes an inlet 6 for the reception therein for coins, currency or the like to auger in the inception of play. A plurality of decision-making buttons 12 are located on the face of the apparatus 10, preferable below the display 2, and a pull handle 14 can be used to initiate play as an alternative to supplement the decision-making buttons 12. A coin hopper 18 or other payment methods, i.e., ticket printers, may be included to effectuate an output of an award due the player. The device 10 may have a top portion 32 with a display thereon having a motif correlative with the game to be played and can include a paytable. A plurality of speakers 34 may be included on the device for aural interaction with the player. The apparatus also includes a processor P coordinating all functions and a random number generator G operatively coupled thereto for generating outcomes. The processor P includes a data structure storing data corresponding to game indicia, e.g. symbols for the game of the type as hereinafter described. A card 9, having a read/write instrumentality 17 thereon, can be read via input 7 as a substitute for or supplement to credit transfers as well as player identification.

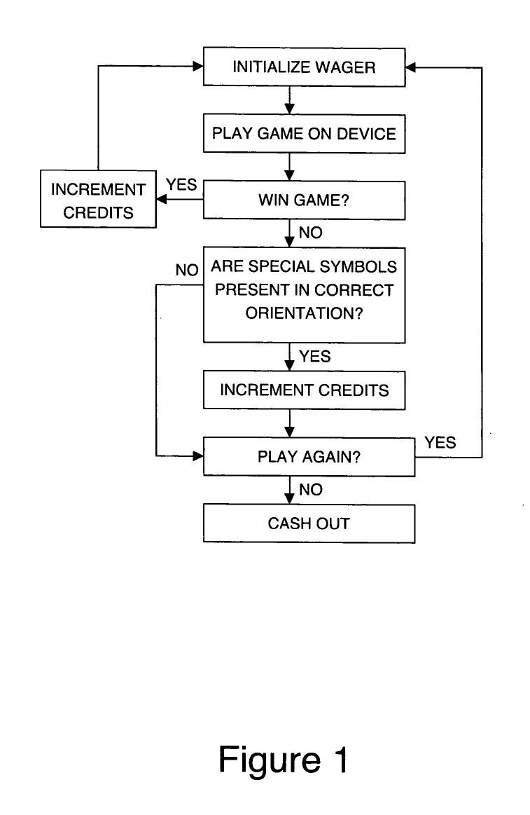

Referring to FIG. 1, the flow chart associated with the present invention can be explored. The device 10 is enabled when a player deposits a wager. The features of the present invention are preferentially operative upon the deposit of a maximum wager. Assume a maximum wager is deposited. A primary game appears for play on the display 2. The primary game may be of any type, but is preferably a multiple reel type game having reels R₁, R₂, R₃, R₄ . . . R_{N}. The primary game outcome has at least one pay line P₁ defined on the game display 2 that is compared to a paytable and the player is awarded credits for any matching outcomes (i.e., outcomes found on the payable). That is, the processor P randomly selects indicia stored in the data structure and controls the display 2 to display the indicia in a fashion simulating the spinning and stopping of the reels R₁, R₂, R₃, R₄ . . . R_{N} to present the selected indicia in a matrix-form at the display 2. The display 2 may have a plurality of pay lines P_{1-N}. If the primary game outcome as defined by the indicia (symbols) selected and displayed at the display 2 on any activate pay line P_{1-N} is not found on the pay table setting forth the winning pay line outcomes, the primary game pay line outcome is a loser. Any winning indicia combinations result in the issuance of an award.

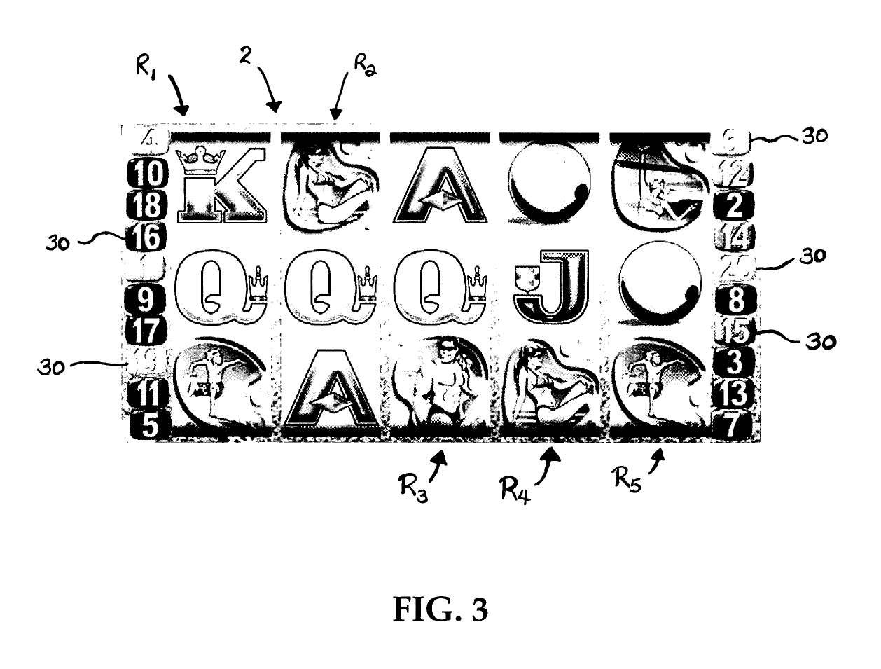

FIG. 3 illustrates a primary game outcome and more particularly a winning pay line outcome. The display 2 displays a plurality of markers 30 each of which denotes an activated pay line for the display 2. The processor P controls the display to display the selected indicia in a matrix-form with five reels R₁₋₅. The selected and displayed indicia on each activated pay line are compared to a schedule of predetermined winning pay line combinations. With reference to FIG. 3, the pay lines which include the three Q-Q-Q symbols would, for example, represent winning pay line outcomes.

The primary game may also include designated scatter pays (not shown) which result in a base game award when two or more designated indicia are selected and displayed, for example, anywhere in the primary game matrix. Scatter pay awards are well known in the art.

The primary game may further include a bonus feature of the type known in the art. For example, when a number of indicia are selected and displayed anywhere or in a predetermined relationship (such as on an activated pay line or on adjacent reels), a bonus feature is enabled.

With reference to FIG. 3, it is typical that the indicia in a game display such as the one shown in FIG. 3 are displayed serially in a right to left fashion to simulate the spinning and serial stopping of the reels R₁₋₅. A player watching the game would understand as the reels stop that he/she has or may receive a winning outcome. For example, if combinations of three of the same indicia are required for a pay line award and the game pays for combinations from left to right, the player would know by the time the second or third reels stop whether they are likely to receive a pay line winning outcome. That is, if no two of the same indicia are on an activated pay line, the player knows by the stopping of the second reel R₂ that he/she will not receive a pay line award. Further if a number of symbols are required for a primary game scatter pay or bonus feature trigger, the player knows by the stopping of the fourth reel R₄ whether they will receive a scatter pay or bonus trigger. In regards to these pays, the player further knows that as the reels stop without displaying scatter or bonus feature indicia, the chances diminish. Thus the player, during the display of the indicia, loses interest as the primary game symbols are displayed without giving any indication that a primary game winning outcome will be obtained.

There is a need for a gaming device and method which retains the player's interest during the display of all reels. Accordingly the present invention is directed to a device and method where the player has an opportunity to obtain a winning outcome until the display of the final reel R₅.

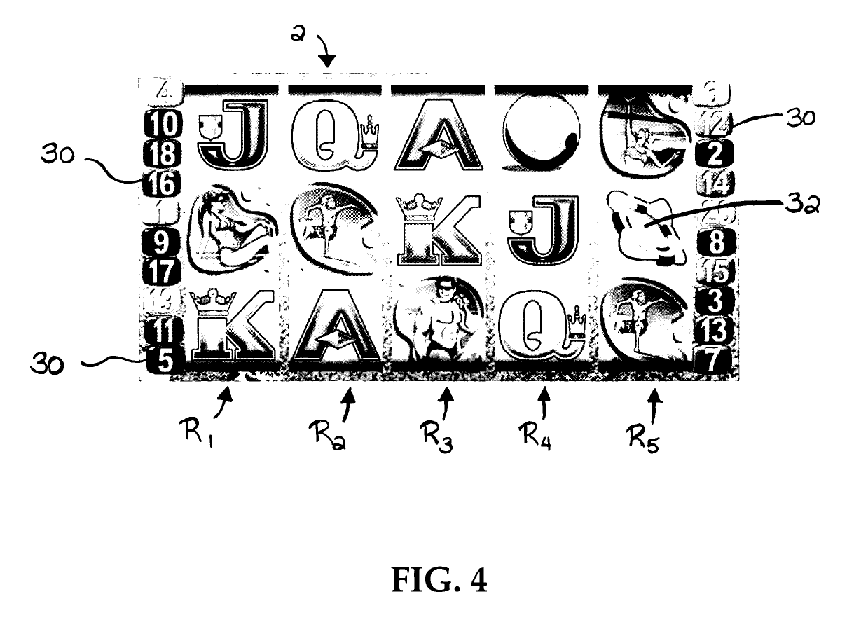

Returning to FIG. 1 and with further reference to the example of an outcome shown in FIG. 4, if the processor P has determined that the indicia displayed at the display 2 do not represent a winning pay line outcome, winning scatter outcome or a bonus trigger (i.e. a primary game winning outcome) the processor P tests the selected and displayed indicia for the presence of a special symbol. Preferably, the primary game outcome is examined to determine if the feature or special symbol 32 is displayed on the fourth or fifth reels, R_{4,5} to retain the player's interest in the game throughout the displays of all symbols. If the special symbol 32, shown as a life preserver, is selected and displayed on one of/the designated reels or in the designated position (such as a designated coordinate in the display matrix, or reel and the primary game outcome is otherwise a losing (non-winning) outcome, the player is entitled to an award. If the symbol is not present or is not in the proper orientation, the player is not awarded, and is given only the opportunity to play again or to cash out.

The award may be enhanced where more than one special symbol 32 is selected and displayed. It should be understood that a winning primary game outcome (pay line, scatter or bonus trigger) will negate and nullify any award associated with the special symbol 32.

After determination of any primary game award or special symbol award, the player is awarded credits and then offered the opportunity to play again or to cash out.

Further embodiments include, but are not limited to: the use of a progressively increasing pot for the award, awarding the player only if the symbol is located in a particular row or column in a multiline array, awarding the player only iF the symbol is displayed on an activated pay line of a particular “reel”, issuing an award only if the special symbol is displayed in a particular coordinate of the display matrix or providing enhanced awards if multiple symbols are located on the display (for example, on the fourth and fifth reels simultaneously).

Moreover, having thus described the invention, it should be apparent that numerous structural modifications and adaptations may be resorted to without departing from the scope and fair meaning of the instant invention as set forth hereinabove and as described herein below by the claims.

I claim:

1. An improved gaming device of the type having a display, means for a player to input a wager and a computer processor configured to select and display a plurality of indicia defining outcomes, said improvement comprising:
a data structure storing data corresponding to game indicia and at least one feature indicia;
said processor configured to select and control the display to display game indicia to define a primary game winning or a losing outcome;
said processor configured to issue an award upon (1) the selection and display of said feature indicia and a primary game losing outcome.

2. The improved gaming device of claim 1 comprising said display configured to display at least one pay line, said processor configured to determine the indicia selected and displayed at the display in association with a pay line defining a primary game winning or a losing outcome.

3. The improved gaming device of claim 1 comprising said processor and display configured to display said feature indicia at said game display.

4. The improved gaming device of claim 1 comprising a plurality of displays, said processor configured to control at least one display to display primary game indicia and the other said feature indicia.

5. The improved game of claim 2 further comprising said data structure including a plurality of scatter pay indicia

6. A gaming device, comprising, in combination:
a display;
wagering means;
a processor operatively intercoupled between said wagering means and said display to activate said display upon receipt of a wager by said wagering means;
a primary game having a plurality of outcomes, at least one of which is recognized by a paytable, each said outcomes formed from a plurality of symbols and shown on said display; and
an award paid to a player if said outcome shown on said display is not on said paytable, but said outcome contains a particular symbol in a particular orientation in said outcome.

7. A method of gaming, the steps including:
accepting a wager;
activating a display;
displaying a primary game;
awarding credits for winning outcomes in said primary game;
searching said outcome for a particular symbol in a particular orientation if said outcome is not a winning outcome; and
awarding credits if said particular symbol is in said particular orientation and said outcome is not a winning outcome.

8. The method of claim 7 including placing said particular symbol on an activated payline.

9. The device of claim 1 further including:
an enhanced award paid to a player if said outcome shown on said display is not on said paytable, but said outcome contains a second said symbol in a second particular location.

10. A gaming device, comprising, in combination:
a paytable having a plurality of outcomes, each said outcome comprising a plurality of symbols;
a primary game displaying one said outcome;
comparison means to determine if the one said outcome is on said paytable;
award means to award credits for outcomes found to be on said paytable by said comparison means; and
second comparison means to determine whether a plurality of particular said symbols are located in a particular orientation in said outcome if said outcome is not present on said paytable.
